(19) United States
(12) Patent Application Publication
(10) Pub. No.: US 2006/0031149 A1
(43) Pub. Date: Feb. 9, 2006

(54) Investment vehicle and methods and systems for implementing investment strategy

(76) Inventors: Timothy J. Lyons, Westerville, OH (US); Trey Rouse, Columbus, OH (US); Douglas C. Mangini, Little Silver, NJ (US); Steven E. Gradeless, Dublin, OH (US); Eric Henderson, Lewis Center, OH (US)

Correspondence Address: Daniel H. Golub, 1701 Market Street, Philadelphia, PA, 19103, US

(21) Appl. No.: 10/910,970

(22) Filed: Aug. 4, 2004

(51) Int. Cl. G06Q 40/00

(52) U.S. Cl. 705/35

(57) ABSTRACT

Implementing an investment strategy to be executed for an individual investor in a single financial contract, covering a plurality of assets. The assets underlying the financial contract are managed using at least a tactical and a strategic asset allocation model. Information regarding risk tolerance, investing time horizon and investment needs of the investor is used to determine (i) a combination of tactical and strategic asset allocation models to manage the assets in the contract; and (ii) a relative percentage of allocation of the assets between the tactical and strategic asset allocation models.

### FIELD OF THE INVENTION

The present invention relates to investment vehicles, and methods and systems for implementing an investment strategy.

### BACKGROUND OF THE INVENTION

Institutional investors have popularized an asset allocation strategy frequently referred to as “core-satellite”. The core-satellite concept leverages a traditional buy and hold investment strategy (the core) along with one or more tactically managed satellite funds, which serve as hedges or risk diversification strategies complimenting the core. However, this strategy has not been used for individual investors in a way that allows the individual investor to capitalize on combining both strategic and tactical asset allocation strategies in a single product chassis.

### SUMMARY OF THE INVENTION

The present invention is directed to an investment vehicle. The investment vehicle comprises a single financial contract that covers a plurality of assets. At least certain of the assets are invested in accordance with a tactical asset allocation model and at least other certain of the assets are invested in accordance with a strategic asset allocation model.

The present invention is also directed to a further investment vehicle that comprises a single financial contract that covers multiple assets. At least certain of the assets are invested in accordance with multiple tactical asset allocation models.

Moreover, the present invention is directed to a method for implementing an investment strategy. Assets underlying a single financial contract are selected. The assets are managed using at least two asset allocation models. The asset allocation models comprise at least a tactical asset allocation model and a strategic asset allocation model. The contract is issued.

The present invention is also directed to a method for implementing an investment strategy to be executed for an individual investor in a single financial contract, which covers a plurality of assets. Risk tolerance, investing time horizon and investment needs of the investor are determined. Based on, at least, the determined risk tolerance, the investing time horizon and the investment needs, (i) a combination of one or more tactical asset allocation models and strategic asset allocation models to manage the assets in the single financial contract; and (ii) a relative percentage of allocation of the assets between the tactical asset allocation models and the strategic asset allocation models are determined.

Finally, the present invention is directed to a system for implementing an investment strategy to be executed for an individual investor in a single financial contract, which covers a plurality of assets. At least one user station is connected to at least one server via a communications network. The server interactively receives from the user station risk tolerance information, investing time horizon information and investment needs information of the individual investor. The server determines based on, at least, the risk tolerance information, the investing time horizon information and the investment needs information, (i) a combination of one or more tactical asset allocation models and strategic asset allocation models to manage the assets in the single financial contract; and (ii) a relative percentage of allocation of the assets between the tactical asset allocation models and the strategic asset allocation models.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1A illustrates an exemplary asset allocation scheme of the present invention;

FIG. 1B illustrates an exemplary contract issued in accordance with the present invention;

FIG. 1C illustrates an exemplary contract issued in accordance with the present invention;

FIG. 2 illustrates a preferred embodiment of a method of the present invention;

FIG. 3 illustrates a preferred embodiment of a system of the present invention;

FIG. 4 illustrates a preferred embodiment of a method of the present invention;

FIGS. 5 through 10 illustrate exemplary screen shots that may be used in accordance with a preferred embodiment of the present invention;

FIG. 11A illustrates a preferred embodiment of a method of the present invention;

FIG. 11B is an exemplary representation of the tool of the present invention; and

FIG. 11C is an enlarged view of the model represented in FIG. 11B.

### DETAILED DESCRIPTION OF THE PREFERRED EMBODIMENTS

Strategic asset allocation seeks to achieve low covariance of asset classes to minimize portfolio risk. Strategic asset allocation involves spreading an investor's assets across and within equities, bonds, cash and other asset types to lower the risk of negative portfolio returns relative to the investor's risk tolerance and investment time horizon in a buy and hold strategy. It is longer term in nature and not necessarily designed to beat the corresponding market indices. Rather, it is designed to track the corresponding market indices matching the asset classes chosen to the client's risk tolerance. Tactical asset allocation is shorter term in nature and is designed to beat the market by underweighting or overweighting specific asset classes relative to the then current (shorter term) market conditions and, in some cases, by extending low covariance of asset classes to inverse correlation. A strategic asset allocation strategy generally produces favorable returns for the investor in periods when the investment markets are going up. While tactical asset allocation methods can also show real returns in up markets, the focus of such methods is either to pursue real returns in downward and sideways markets, or to provide a hedge on the core portion of the portfolio.

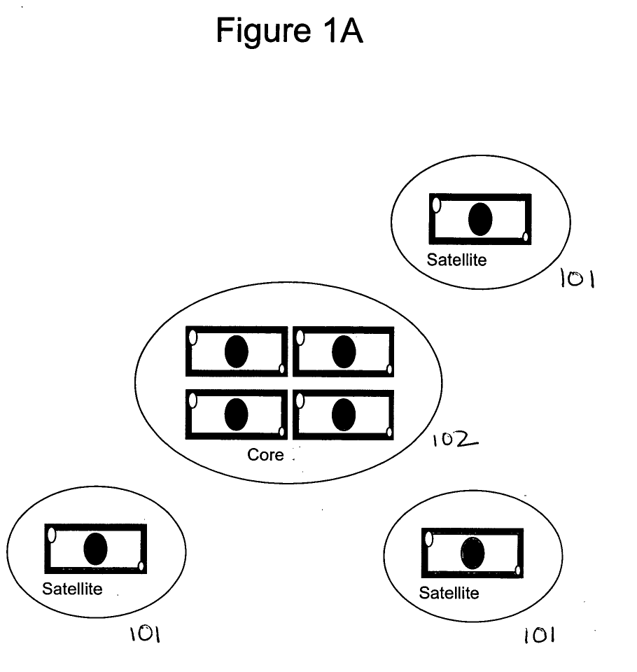

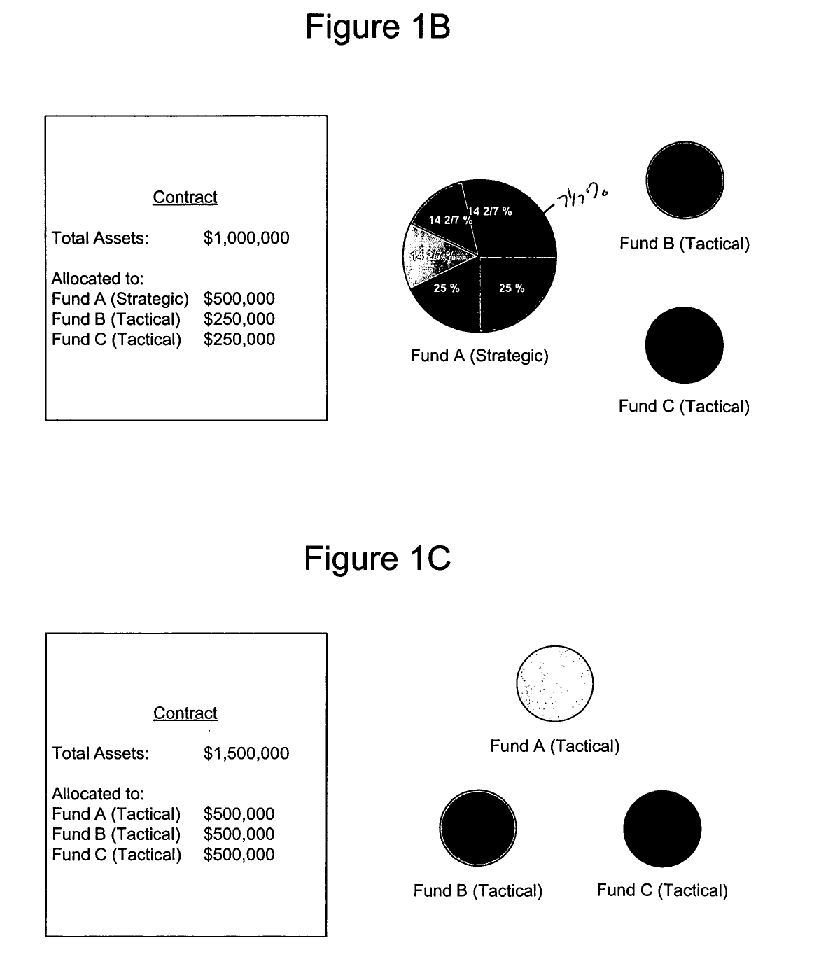

The investment vehicle of the present invention is comprised of a single financial contract covering a plurality of assets. The assets are allocated in accordance with multiple asset allocation models. With reference to FIG. 1A, at least certain of the assets are invested in accordance with one or more tactical asset allocation models 101 (the “satellites”) and at least certain other of the assets are invested in accordance with a strategic asset allocation model 102 (the “core”). In one embodiment of the invention, the assets are invested in accordance with multiple tactical asset allocation models, without a portion thereof being invested in accordance with a strategic asset allocation model in a single contract. The financial contract is, in one embodiment, a variable annuity contract or a variable life contract. However, other types of financial contracts may be used in accordance with the present invention. Indeed, the inventive tool could be applied against any product leveraging equity or bond instruments.

Thus, for example, with reference to FIG. 1B, a financial contract worth $1,000,000 issued to an investor may include $500,000 worth of assets invested in accordance with a strategic asset allocation model; $250,000 worth of assets invested in accordance with a first tactical asset allocation model; and $250,000 worth of assets invested in accordance with a second tactical asset allocation model. With reference to FIG. 1C, a financial contract worth $1,500,000 issued to an investor may include $500,000 worth of assets invested in accordance with each of three different tactical asset allocation models.

There are several practical advantages to an investor of having multiple models (including both strategic and tactical, or multiple tactical) in a single contact. For instance, the investor will receive a single statement. In addition, if the investor is interested in changing the allocation of assets, he need not obtain a different contract; instead, assets can simply be moved within the contract. The fees paid by the investor may also be impacted by holding a single, as opposed to multiple, contracts. Often, the core portion of the portfolio can help to provide a lower cost of the combined portfolio by using low cost core funds to offset the higher expense of underlying funds used in the satellite strategy. Importantly, the investor gains a great deal of flexibility in his investment objectives, as the present invention provides a mechanism for combining short and long term investment objectives in a single contract. The advantages to the issuer of the financial contract are also apparent, in that the invention provides a single product for varying market conditions. Similarly, the financial contract producers also benefit from the invention in that it provides a single, easy to use, turnkey product for varying market conditions; broadens risk management alternatives; and represents a new model to address principle protection.

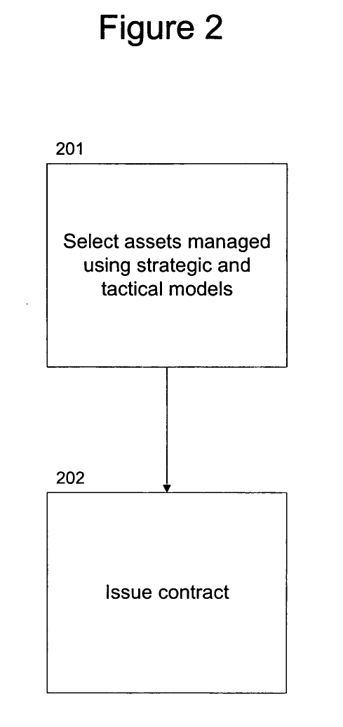

With reference to FIG. 2, a flow chart illustrating a method for implementing an investment strategy is shown. In step 201, assets underlying a single financial contract are selected, wherein the assets are managed using at least two asset allocation models, the asset allocation models comprising at least a tactical asset allocation model and a strategic asset allocation model. In step 202, the contract is issued.

The present invention also provides a tool that addresses the combination of both strategic and tactical models in a single financial contract and the relative percentage allocation of the portfolio between strategic and tactical over changing (i.e., time) market conditions. The tool is interactive in nature and, in a preferred embodiment, is accessible via the Internet. Traditional strategic asset allocation questions are asked to determine the investor's risk tolerance, investing time horizon, and general investment needs. The tool then goes beyond traditional asset allocation questions to include questions related to tactical models, net worth and investor suitability. Based on the investor's responses to the questions, the tool will recommend both a strategic asset allocation as well as suggested tactical strategies in combination. The tool will also recommend the percentage of the portfolio that is allocated to the strategic model and one or more tactical models. Pre-determined models may be used in connection with this embodiment; the model that best suits the needs of the investor will be recommended by the tool.

In another embodiment, a financial advisor to the investor is given the opportunity to enter his/her personal forward-looking market assessment based on the predicted direction and volatility of key market indices and economic indicators. In this embodiment, the particular models from which the tool selects may be developed by the financial advisor.

The tactical models suggested by the tool will be driven from the answers to the risk tolerance and investment objective questionnaire, with the optional advisor outlook, in combination with assessments and modeling of then current market (Alpha) opportunities (manifested within the tactical models). In one exemplary embodiment, the tool is structured to allow periodic rebalancing and allocation of the portfolio structure.

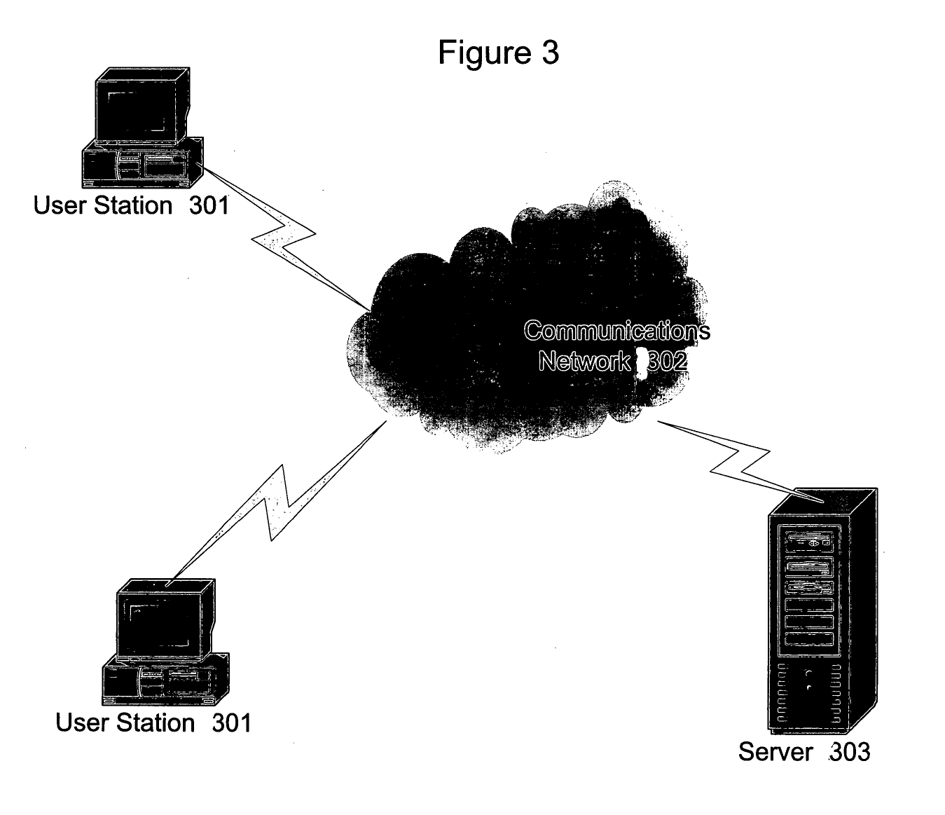

With reference to FIG. 3, a system for implementing an investment strategy to be executed for an individual investor in a single financial contract (comprising a plurality of assets) is shown. A user station 301 is connected to a server 303 via a communications network 302, such as a WAN or LAN. The server 303 interactively receives from the user station 301 risk tolerance information, investing time horizon information and investment needs information of the individual investor; and determines, based on at least the risk tolerance information, the investing time horizon information and the investment needs information, (i) a combination of one or more tactical asset allocation models and strategic asset allocation models to manage the assets in the single financial contract; and (ii) a relative percentage of allocation of the assets between the tactical asset allocation models and the strategic asset allocation models.

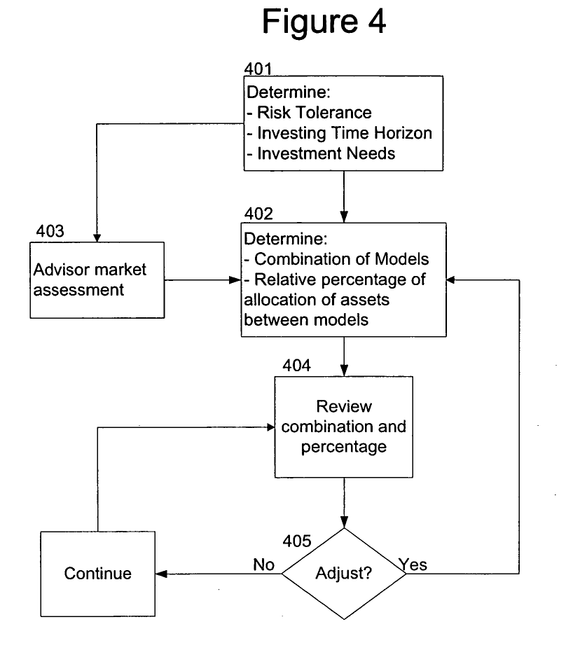

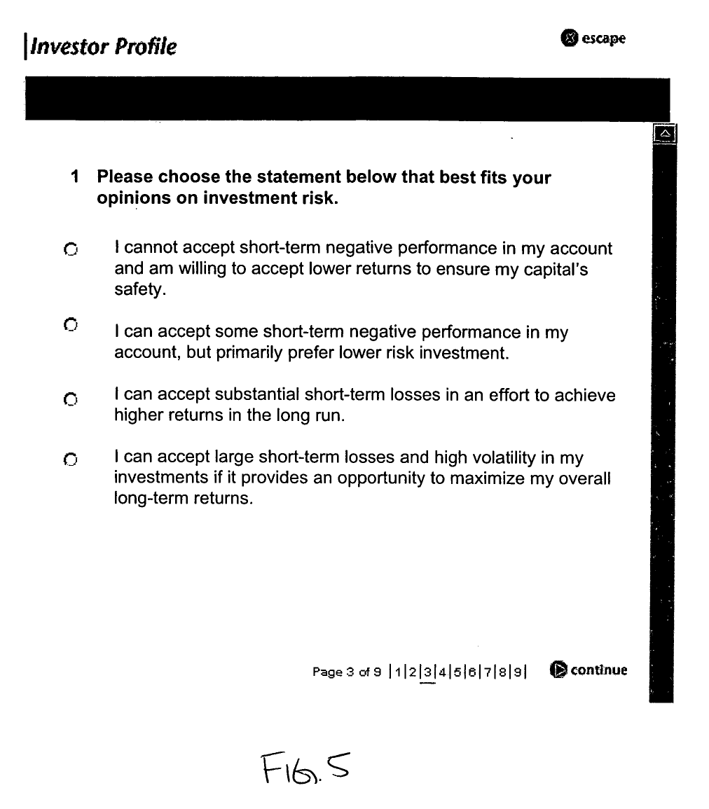

With reference to FIG. 4, a flow chart illustrating a method for implementing an investment strategy is shown. The investment strategy is to be executed for an individual investor in a single financial contract, comprising a plurality of assets. In step 401, risk tolerance, investing time horizon and investment needs of the investor are determined. Based on at least the determined risk tolerance, the investing time horizon and the investment needs, in step 402, (i) a combination of one or more tactical asset allocation models and strategic asset allocation models to manage the assets in the single financial contract; and (ii) a relative percentage of allocation of the assets between the tactical asset allocation models and the strategic asset allocation models is determined. In some embodiments, the relative percentage of allocation of the assets is determined as a function of changing market conditions. In step 403, a market assessment of an advisor to the investor based at least on a predicted direction and volatility of market indices and economic indicators is determined. The determinations made in step 402 are further based on the market assessment. In steps 404 and 405, on a periodic basis, the combination and the relative percentage is reviewed to determine any adjustments thereto

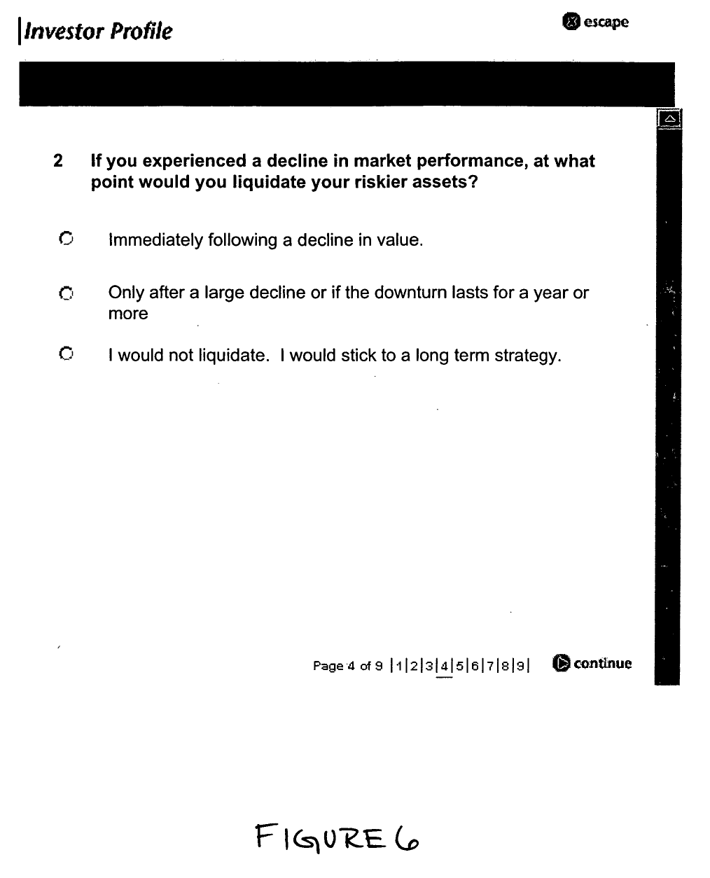

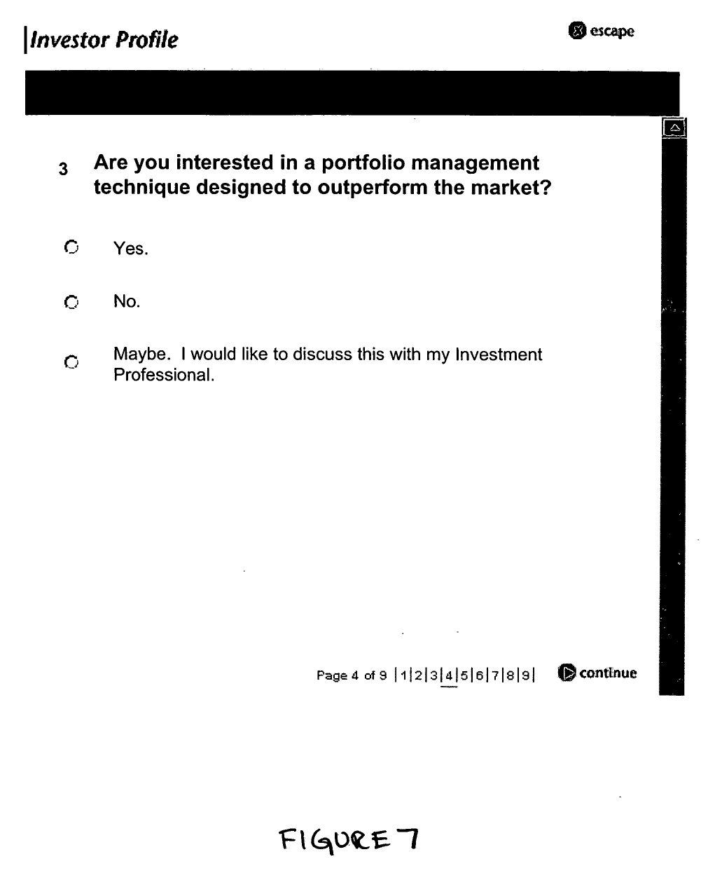

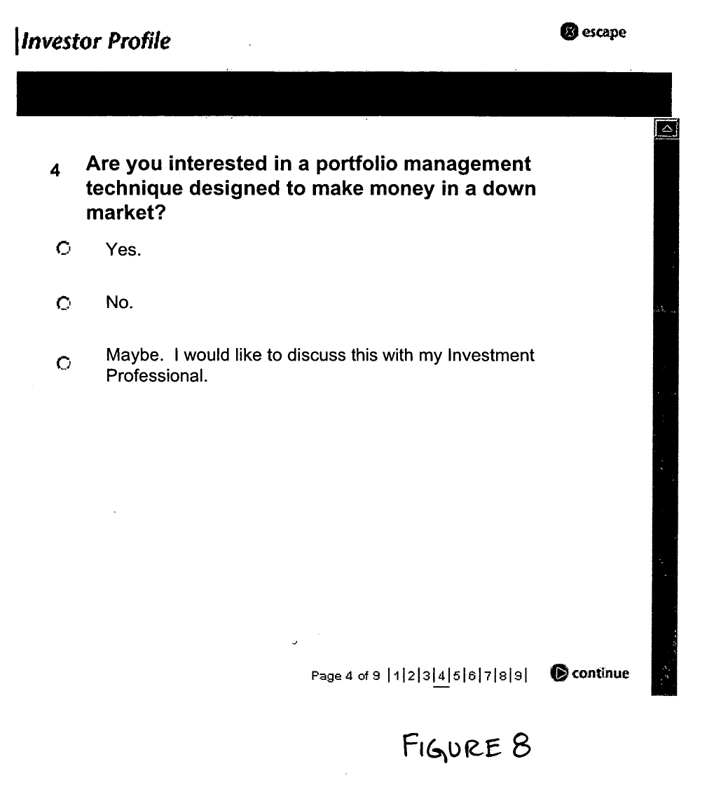

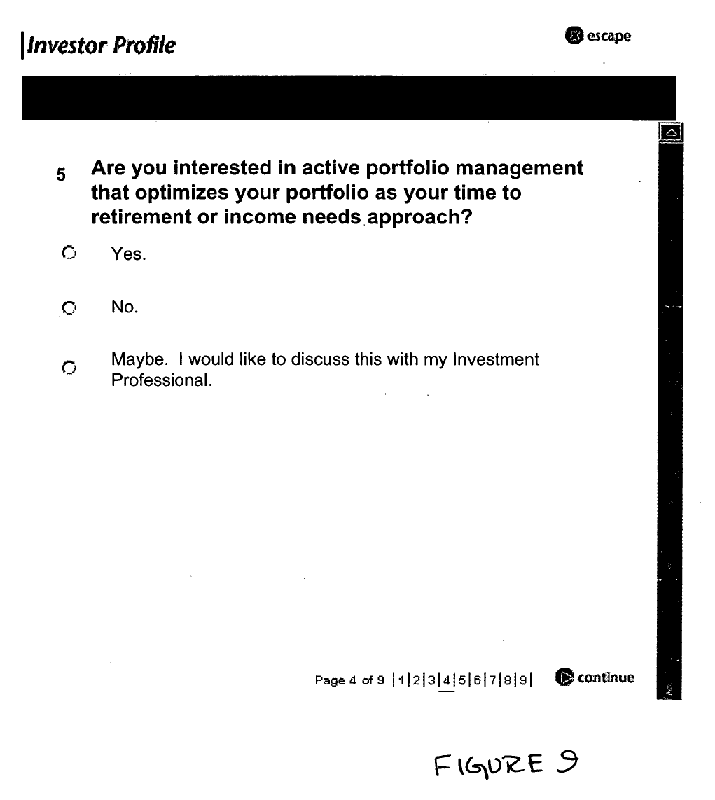

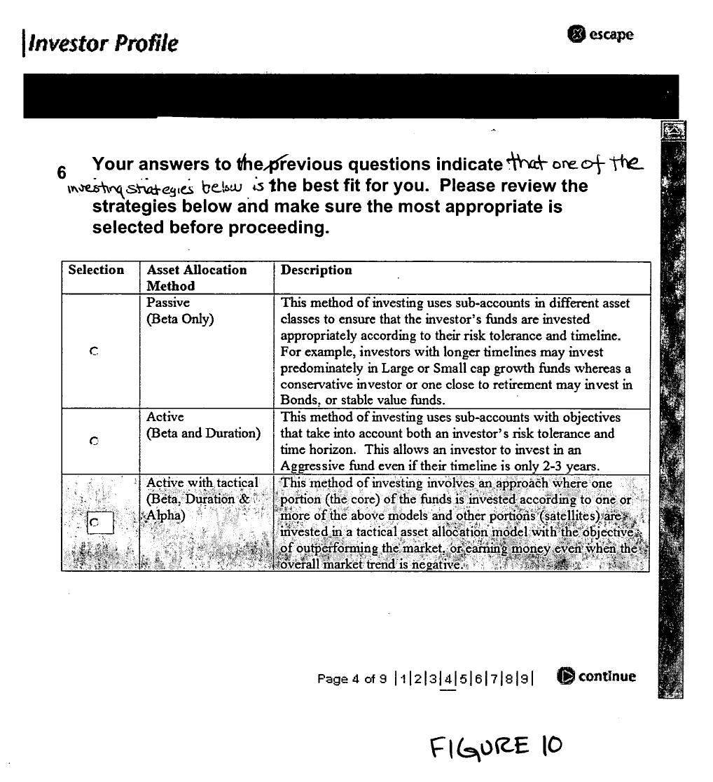

With reference to FIGS. 5 through 10, screens from an exemplary user interface for using the present invention are illustrated. With reference to FIGS. 5-9, the investor may be asked various questions by way of a questionnaire, the responses to which may be used to develop a fund selection strategy. The questionnaire goes beyond current typical strategic asset allocation tools in a number of ways as it can optionally serve as a suitability questionnaire and input to an Investment Policy Statement. Questions related to liability management and net worth focus on a deeper understanding of the investable asset and duration liquidity of those assets. Questions on the time to retirement or income-need will be used to create duration-based or age-based portfolio dimensions. For example, a moderately aggressive customer with five years to retirement will have a different asset mix than a moderately aggressive customer with twenty-five years to retirement. There may be additional questions which serve to determine the investor's interest in and need for tactical strategies to achieve their investment objectives.

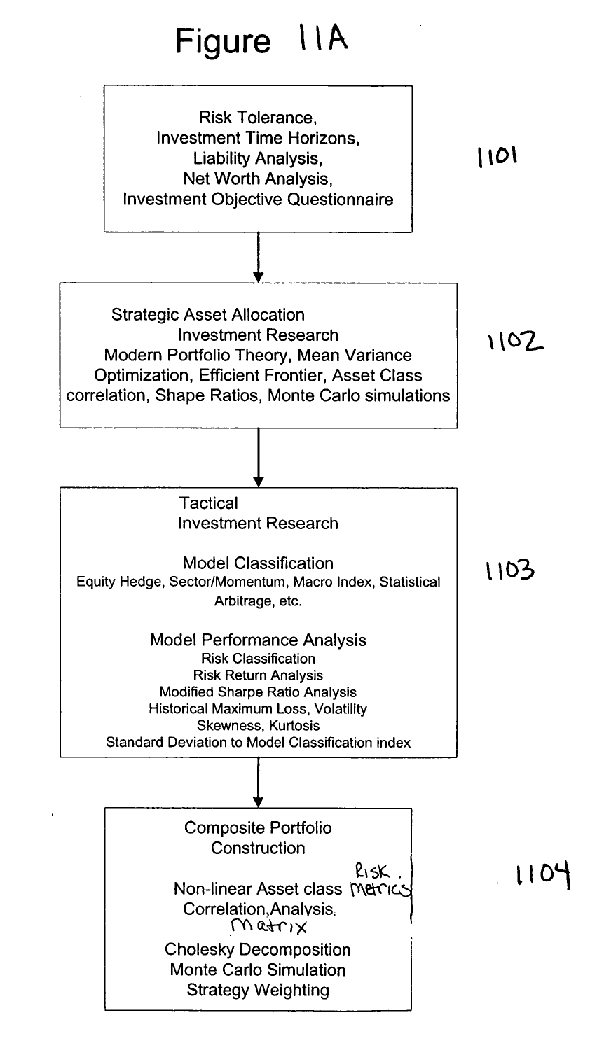

Upon analyzing the advisor or investor responses to all questions, a proposed multiple asset allocation model investment strategy will be presented, with reference to FIG. 10.

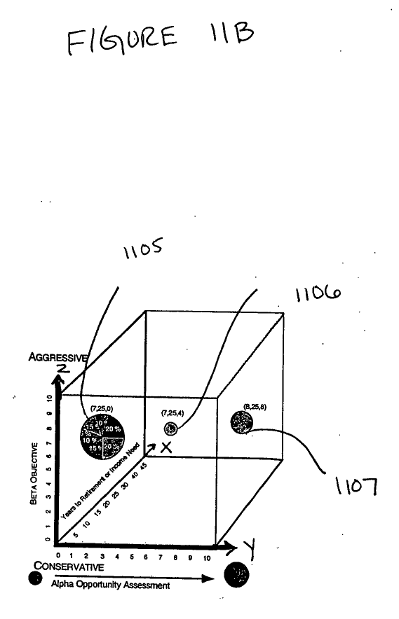

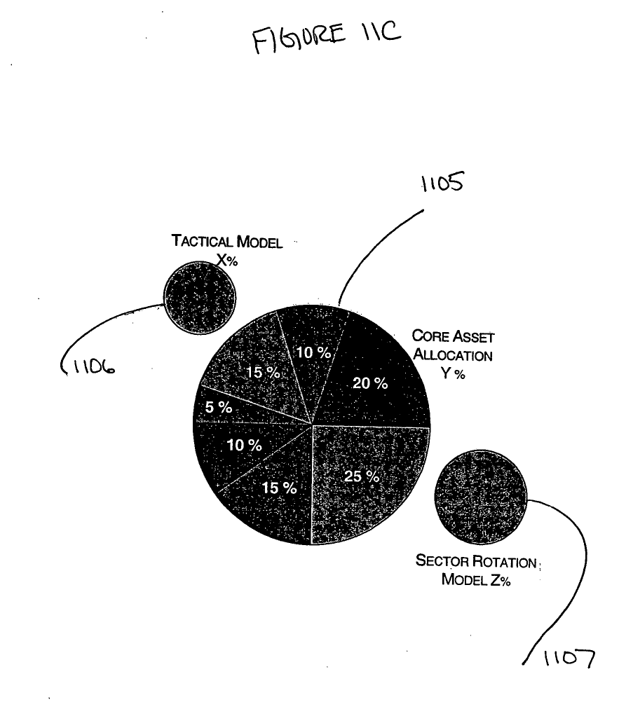

With reference to FIGS. 11A, 11B, and 11C, the inventive tool is illustrated. FIG. 11A is a flow chart illustrating the steps taken in gathering and analyzing data in connection with a preferred embodiment of the present invention. Steps 1101 and 1102 represent the core analytics associated with Modern Portfolio Theory. The investor's risk tolerance and investment time horizons are explored. In addition, a liability and net worth analysis are performed. Further, answers to questions included in an Investment Object Questionnaire, including questions such as those illustrated in FIGS. 5-9, are obtained. Thus, the investor's investing experience may be explored, along with his comfort with risk, which includes introducing the concept of tactical asset allocation modeling into his portfolio. His investment time frame and volatility of investable assets may also be explored. In step 1102, strategic asset allocation research is performed. This includes applying traditional strategic asset allocation theories to the investor's assets.

Step 1103 represents the methodology used for tactical model risk assessment and categorization. These models are alpha or excess-return focused, where alpha is the difference in the expected return of the portfolio given the portfolio's beta and the actual return the portfolio achieved. The activities performed in this step provide a way to measure and correlate alternative investments. The analytics employed are quite different in nature from those used for traditional equity analysis. The analytics used to assess risk/return analysis and general asset class categorization of tactical models correspond closely to those used in hedge fund, derivatives, or other alternative investments. For example, assume a question is raised regarding how to compare the risk /return characteristics for a portfolio consisting of stocks, mutual funds, fine art and antiquities. While it may be relatively straight-forward to analyze risk/return tradeoffs between large caps versus small cap stocks due to the underlying correlation, an entirely new set of measures is needed for non-correlated asset types. For example, comparing the predicted behavior of a modern art piece versus shares of a publicly-traded stock requires different analytics. The tool leverages these types of analytics for tactical models.

Thus, a risk performance analysis is introduced that is not typically performed with traditional investment instruments. First, tactical strategies are classified into different categories. Then, model performance analysis is performed. This provides the ability to classify risk, and measure models relative to their classification. The model performance analysis may include classification of risk, risk return analysis, Modified Sharpe Ratio Analysis, historical maximum loss measurements, volatility skewness and kurtosis measurements, analysis related to standard deviation to model classification index, as well as other measurements and analyses, some of which are described in more detail below. Modified Sharpe Ratio Analysis, skewness and kurtosis focus on alternative investment vehicle analysis.

Skewness measures the coefficient of asymmetry of a distribution of returns. A risk-averse investor does not like negative skewness. Kurtosis measures the degree of fat tails of a distribution. A risk-averse investor prefers a distribution with low kurtosis (i.e., returns are not far from the mean). In the theoretical approach below, the kurtosis is an excess kurtosis. A distribution, to be normal, should have at least an excess kurtosis is equal to 0. In case of positive skewness, it is possible to have a high excess kurtosis (higher than 3 or 4) and to have no risk of extreme negative returns in the future. The extreme returns will only be positive. As soon as the skewness begins to be negative, the impact of a high excess kurtosis is significant for a risk-averse investor.

When the return distribution has a skewness of −1 (or below) and an excess kurtosis higher than 1, the probability to have large negative returns increases dramatically. For a distribution with a skewness of −1 and an excess kurtosis of −5 (i.e., technology stocks, media stocks, telecom stocks or hedge funds have this kind of excess kurtosis level), a mean-variance approach will conclude that the investor will not loose more than −3.5% in the next 1 day with 99% probability. An approach, which accounts for skewness and kurtosis, gives −7.4% loss in the next 1 day with 99% probability. The difference is more than 100% of underestimation with the use of the mean-variance.

The Sharpe ratio is a measure used in portfolio management in order to compare different portfolios, stocks or indices. The Sharpe ratio is valid if the asset are normally distributed or if the investor has a quadratic utility function. This means that the portfolio is completely described by its mean and volatility. As soon as the asset is invested in technology stocks, distressed companies, hedge funds, or high yield bonds, by way of example, the ratio is no longer valid. The risk comes not only from the volatility, but from higher moments like skewness and kurtosis.

The opposite of the Modified Sharpe Ratio is the ratio of the excess return divided by the Modified Value-at-Risk. If the returns are normally distributed, the modified Sharpe ratio converges to the classical Sharpe. This Modified Sharpe Ratio measures portfolio with derivatives payoffs returns. Two portfolios with the same mean and the same volatility will be separated by their extreme losses. This is the advantage to working with Modified Value-at-Risk and Modified Sharpe ratio. The concept was developed by Favre and Galeano, Journal of Alternative Investments, Fall 2002 (incorporate herein by reference), in connection with Modified Value-at-Risk optimization with hedge funds.

In step 1104, the composite portfolio is constructed. As with tactical model analysis, new alternative investment class investment analysis techniques are combined with the familiar Model Carlo Simulation techniques to create recommended blended portfolios of tactical and strategic asset allocation models. With these analytics, portfolios can be constructed and managed wherein the relative risk tolerance of the tactical models is matched to those in the strategic model (e.g., portfolios where the tactical models are more aggressive, or with hybrid models where one tactical model may match the risk tolerance of the strategic pool with an “explore” tactical model, which is more aggressive.)

Two key analytical formulas are introduced to enable this capability. Cholesky Decomposition is a method for transforming uncorrelated normal random variables into correlated normal random variables. Non-Linear Asset Class Correlation and Regression techniques focus on the risk/return relationship between two marginal asset distributions without a single correlated index.

As stated above, Cholesky Decomposition is a method for transforming uncorrelated normal random variables into correlated normal random variables. This is a matrix which has some interesting properties when one is simulating a portfolio of assets. The Cholesky decomposition separates a matrix E in two identical matrices M:

MM^{T} =E

The matrix E is a matrix with the correlation between each asset. The matrix M is called Cholesky matrix. It is a lower triangular matrix. Multiplying the Cholesky matrix M with simulated random vectors will give linearly correlated random returns. Additional information regarding Cholesky Decomposition can be found in P. Wilmott, Derivatives, p.682 (1998), which is hereby incorporated by reference. This technique is used to simulate separately the future possible paths of financial assets.

Correlation is a statistical term giving the strength of linear relationship between two random variables. More simply defined, it is the historical tendency of one thing to move in tandem with another. The correlation coefficient can be a number from −1 to +1, with −1 being the perfectly opposite behavior of two investments (e.g., up 5% every time the other is down 5%), and +1 reflecting identical investment results (up or down the same amount each period). The further away from +1 (and thus closer to −1), the better a diversifier one investment is for the other. The correlation coefficient is found by taking the covariance between two variables and dividing by the square root of the product of each of the two variances.

In sum, the tool allows for measurement of the risk/return characteristics of tactical models as if they were normal asset classes and then combines them into portfolios like any other fund.

With reference to FIG. 11B, a three-dimensional interpretation of the inventive tool is illustrated. The y-axis represents the alpha opportunity assessment (i.e., whether the model is attempting to chase or outperform the market). The further to the right the model moves, the greater the outperform opportunity based on the underlying analytics of the tool/analysis. The z-axis represents the beta objective (i.e., risk tolerance ranging from conservative to aggressive). This axis is focused on strategic asset allocation that is longer term in nature and not necessarily designed to beat the corresponding market indices. Rather, it is designed to track the corresponding market indices matching the asset classes chosen to the client's risk tolerance, meaning it is beta focused. The x-axis represents the number of years until the investor will require income (i.e., years to retirement). This allows for introduction of a finer level of duration or time-based portfolio construction.

The exemplary asset allocation models chosen in accordance with the process described with reference to FIG. 11A are shown in FIG. 11B as 1105, 1106 and 1107. An enlarged version of these models 1105, 1106 and 1107 is shown with reference to FIG. 11C. Each of the spheres in the graph has three-dimensional coordinates. The first coordinate represents the years to income need assigned to the model. The second coordinate represents the alpha opportunity score assigned. The third coordinate represents the investor's risk assessment score. Model 1105 is the core asset allocation model, in accordance with which Y % of the investor's portfolio will be invested. Model 1106 is one of the tactical models, in accordance with which X % of the investor's portfolio will be invested. Model 1107 is one of the other tactical models, in accordance with which Z % of the investor's portfolio will be invested.

In the depicted scenario of FIGS. 11B and 11C, two tactical models are shown. Model 1107, depicting a sector rotation strategy, has a larger allocation than model 1106, depicting an equity hedge model. The alpha opportunity for sector rotation was assigned an 8 ranking versus the equity hedge model, which was assigned a 4 ranking. The core asset allocation strategy represented by model 1105 has an alpha opportunity of zero corresponding to the beta-driven characteristic of strategic asset allocation. In the example shown, all components show 25 years to income need. This could be varied around a tactical strategy relating to a college saving component that occurs in ten years, for example. In this example, all components are relatively close in risk assessment at either seven or eight for the sector-rotation model. The investor could optionally choose to devote a portion of their portfolio to an “explore” strategy with a much higher risk profile.

In the preferred embodiment, each portfolio constructed by the tool will be accompanied by an investment policy statement (IPS). The EPS will document the general composition of the model as well as parameters for changing the asset class and tactical model percentages within some pre-determined tolerance parameters. The more conservative the model, generally the lower the ability to move dollars between and within asset classes and models.

The present invention is intended to embrace all alternatives, modifications and variances that fall within the scope of the appended claims.

What is claimed is:

1. An investment vehicle comprising:
a single financial contract comprising a plurality of assets,
wherein at least certain of the assets are invested in accordance with a tactical asset allocation model and at least other certain of the assets are invested in accordance with a strategic asset allocation model.

2. An investment vehicle comprising:
a single financial contract comprising multiple assets,
wherein at least certain of the assets are invested in accordance with multiple tactical asset allocation models.

3. The investment vehicle of claim 1 or 2 wherein the single financial contract comprises one of a variable annuity contract and a variable life contract.

4. A method for implementing an investment strategy comprising:
A. selecting assets underlying a single financial contract, wherein the assets are managed using at least two asset allocation models, the asset allocation models comprising at least a tactical asset allocation model and a strategic asset allocation model; and
B. issuing the contract.

5. The method of claim 4 wherein the financial contract comprises one of a variable annuity contract and a variable life contract.

6. A method for implementing an investment strategy to be executed for an individual investor in a single financial contract, the single financial contract comprising a plurality of assets, the method comprising:
A. determining risk tolerance, investing time horizon and investment needs of the investor;
B. based on at least the determined risk tolerance, the investing time horizon and the investment needs, determining (i) a combination of one or more tactical asset allocation models and strategic asset allocation models to manage the assets in the single financial contract; and (ii) a relative percentage of allocation of the assets between the tactical asset allocation models and the strategic asset allocation models.

7. The method of claim 6, wherein the relative percentage of allocation of the assets is determined as a function of changing market conditions.

8. The method of claim 6, further comprising
C. determining a market assessment of an advisor to the investor based at least on a predicted direction and volatility of market indices and economic indicators, wherein step B is further based on the market assessment.

9. The method of claim 6, further comprising:
C. on a periodic basis, reviewing the combination and the relative percentage to determine any adjustments thereto.

10. A system for implementing an investment strategy to be executed for an individual investor in a single financial contract, the single financial contract comprising a plurality of assets, the system comprising:
at least one user station; and
at least one server connected to the user station via a communications network
wherein the server interactively receives from the user station risk tolerance information, investing time horizon information and investment needs information of the individual investor; and determines based on at least the risk tolerance information, the investing time horizon information and the investment needs information, (i) a combination of one or more tactical asset allocation models and strategic asset allocation models to manage the assets in the single financial contract; and (ii) a relative percentage of allocation of the assets between the tactical asset allocation models and the strategic asset allocation models.
